(19) United States
(12) Patent Application Publication
(10) Pub. No.: US 2011/0141345 A1
(43) Pub. Date: Jun. 16, 2011

(54) Projected Light Scale for Forensic Photography

(76) Inventors: Paul Ramsey, Pantego, TX (US); David Simon, Alexandria, VA (US)

(21) Appl. No.: 12/967,044

(22) Filed: Dec. 13, 2010

Related U.S. Application Data
(60) Provisional application No. 61/285,736, filed on Dec. 11, 2009.

(51) Int. Cl. H04N 5/225; F21V 5/00

(52) U.S. Cl. 348/370; 362/235; 348/E05.024

(57) ABSTRACT

A Projected Light Scale for Forensic Photography that projects indicators onto a scene which is captured by a digital imaging device. These indicators may be produced by collimated light, resulting in fixed and diverging indicators. This enables a user viewing the captured image to extrapolate the true size of objects within the image, as well as to determine the distance and orientation of the digital imaging device relative to the imaged scene.

### CROSS-REFERENCE TO RELATED APPLICATIONS

This application claims the benefit to U.S. provisional patent application No. 61/285,736 filed on Dec. 11, 2009.

### BACKGROUND

With the rise of crime, terrorism, and the presence of ongoing military conflicts, the requirement to rapidly and accurately capture forensic information is more critical than ever. In practice, the Projected Light Scale for Forensic Photography will enable forensic photographers to rapidly and easily capture evidence with all of the information required to accurately scale imaged objects, as well as the photographers distance and orientation, embedded into the captured image.

Past efforts have related to the use of physical metrics which are manually inserted into the field of view, such as rulers. To speed this process, some forensic photographers have resorted to make-shift approaches in which rulers mounted on rods are held in the camera's field-of-view when images are captured, providing a metric that can be used to scale objects within the captured image. This process is cumbersome, time-consuming, and less accurate due to potential misalignment of the ruler or obscuration of the object of interest.

Accordingly, objects and advantages of the invention are (1) to create a reference scale within a photograph at the time the picture is taken without an external ruler or scale and (2) to create a reference within a photograph which can be used to identify aspects of imaged objects including the orientation, position, and or shape of an object or partial object.

In accordance with the present invention the Projected Forensic Scale is a device used when capturing an image of an object that creates a reference within the captured image which enables the size and other characteristic of objects within the image to determined. This is accomplished without the insertion of a physical scale, or reference object such as a ruler, into the field of view of the imaging device.

### SUMMARY

This invention generally relates to the area of forensic photography. Specifically, the invention relates to the use of digital imaging devices to rapidly and accurately collect forensic information from crime scenes and other areas of interest. This invention projects indicators onto a scene which is captured by a digital imaging device. These indicators may be produced by collimated light, resulting in fixed and diverging indicators. This enables a user viewing the captured image to extrapolate the true size of objects within the image, as well as to determine the distance and orientation of the digital imaging device relative to the imaged scene.

### DESCRIPTION OF THE SEVERAL VIEWS OF THE DRAWINGS

FIG. 1 shows the preferred embodiment of the Projected Forensic Scale (PFS).

FIG. 2 is a view of the rear of the unit showing a power switch and trigger.

FIG. 3 shows the PFS mounted on a camera.

FIG. 4 shows two projected points of light and two projected rings onto an object in an imaging device's field of view (FOV).

FIG. 5 shows two projected points of light and two projected ring onto an object at the same distance from the photographer as the object.

FIG. 6 shows two projected points of light and two projected rings onto an object in an imaging device's FOV where the object is farther from the photographer than the object in FIG. 5.

FIG. 7 shows a orthogonal view of projected diverging ring and a projected point originating from the device.

FIG. 8 shows a top view of two projected diverging rings and projected points originating from the device.

FIG. 9 shows how the projected ring and projected point display on a tilted cube.

FIG. 10 shows the projected ring on the tilted cube from the viewpoint of the PFS and imaging device.

### DETAILED DESCRIPTION

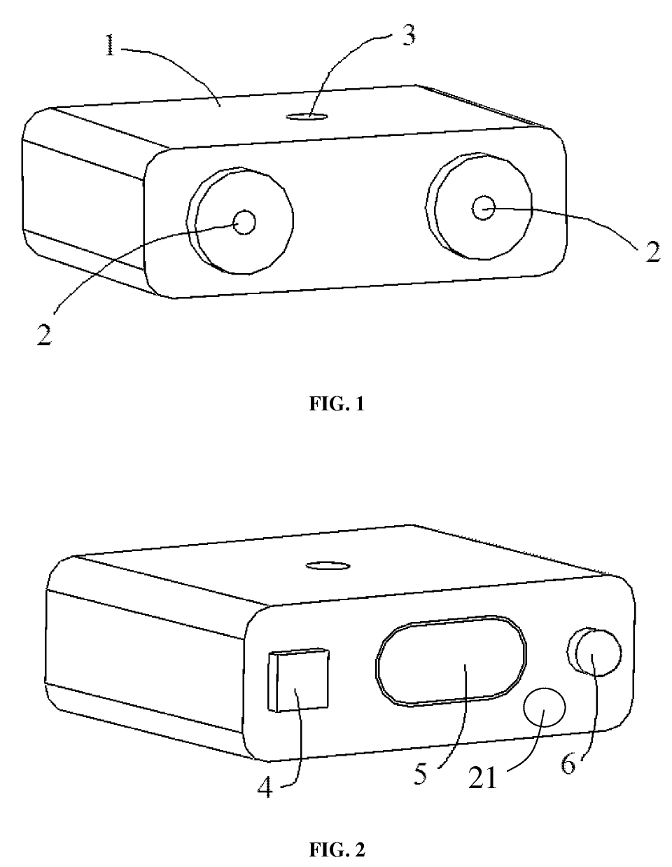

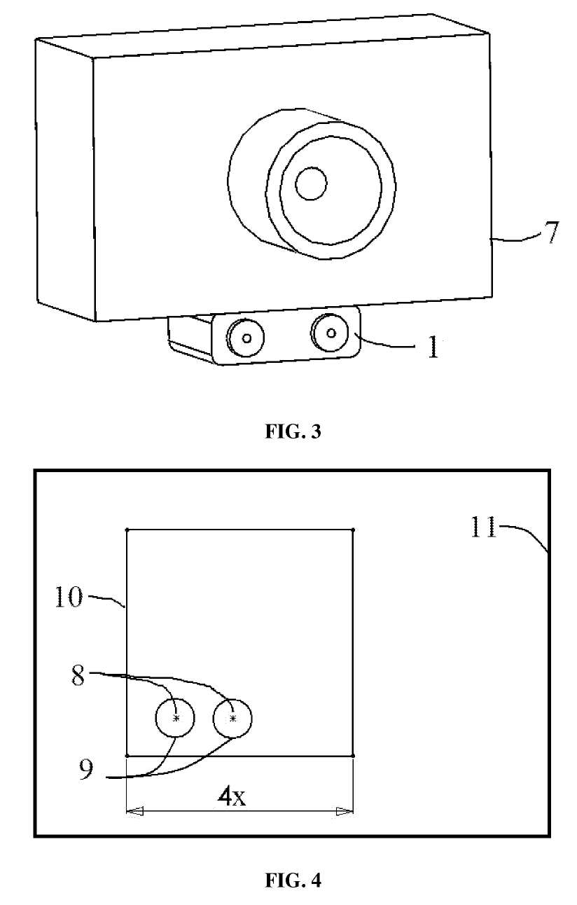

FIGS. 1-3 show the structure of the preferred embodiment of the Projected Forensic Scale (PFS). The PFS 1 contains two light sources with lenses 2 which can be ground, compound, Fresnel, or masked shaped, and a mounting hole 3. The light sources can be lasers, LEDs, or incandescent lights. FIG. 2 is a view of the rear of the unit showing a power switch 4, a power source 5, a power indicator 6, and a trigger 21. FIG. 3 shows the PFS mounted on a camera 7 in the preferred embodiment.

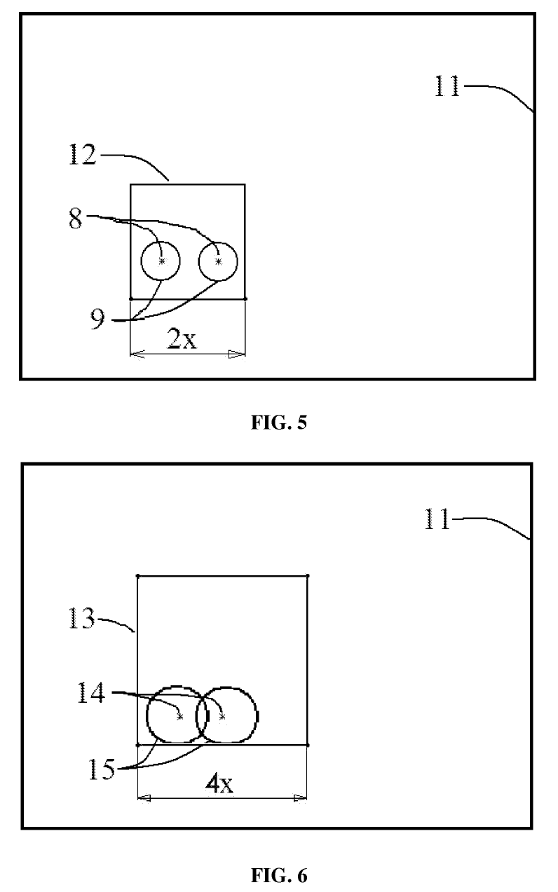

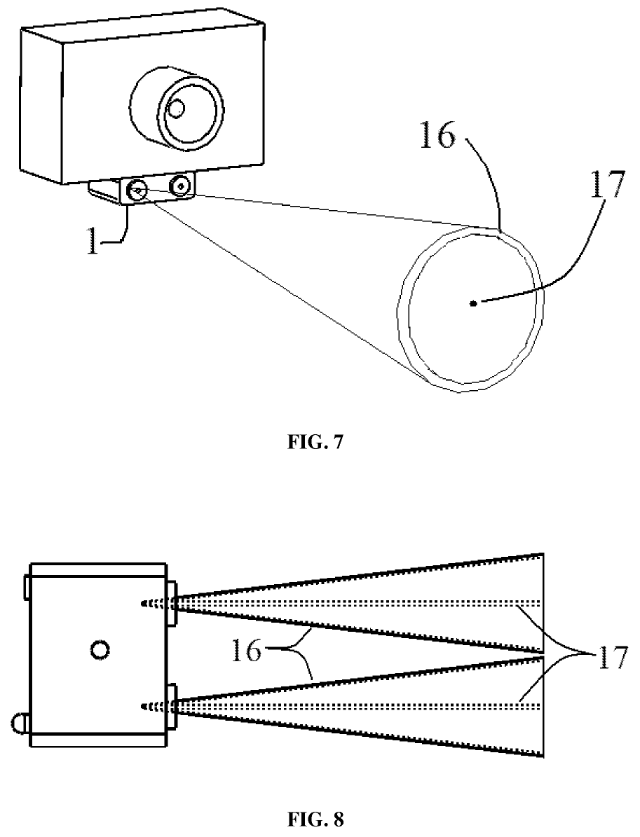

FIGS. 4-8 show how PFS indicates the size and distance of photographed objects. FIG. 4 shows two projected points of light 8 one unit of length apart and two projected rings 9 onto an object 10 with nominal dimensions of four units wide in an imaging device's FOV 11. The distance between the dots is constant, and can be used in a captured image to determine the size of objects within the image, showing in this case, that the object is four units wide. FIG. 5 shows two projected points of light 8 one unit of length apart and two projected rings 9 onto an object 12 with nominal dimensions of two units wide and the same distance from the photographer as object 10 in FIG. 4. The scale indicates that this object is two units wide. FIG. 6 shows two projected points of light 14 one unit of length apart and two projected rings 15 onto an object 13 with nominal dimensions of four units wide in an imaging device's FOV 11. Object 13 is farther from the photographer than object 10 was. In this case, the projected points 14 appear closer together than the points 8. However, the scale indicates that object 13 is the same size as object 10 (four units wide). Unlike the scale, the diverging rings 15 are larger than the rings 9 projected onto object 10 because object 13 is farther from the photographer. FIG. 7 shows a orthogonal view of projected diverging ring 16 and a projected point 17 originating from the device. FIG. 8 shows a top view of two projected diverging rings 16 and projected points 17 originating from the device.

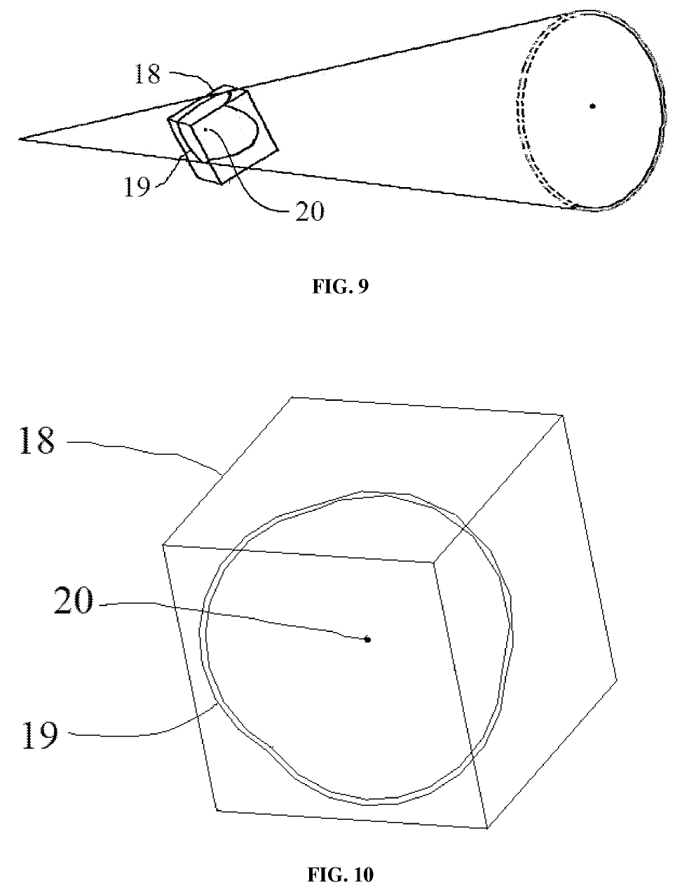

FIGS. 9-10 show how PFS indicates the orientation of the photographed object. FIG. 9 shows how the projected ring 19 and projected point 20 would display on a tilted cube 18. This illustrates another key attribute of the invention: when the circle is projected onto a surface that is not normal to the camera, the circle is distorted. This distortion gives a two-dimensional photograph an indication of the orientation, position, and or shape of the photographed object as well as means to identify the angle and distance at which the image was captured. FIG. 10 shows the projected ring 19 on the tilted cube 20 from the viewpoint of the PFS and imaging device.

The Projected Forensic Scale (PFS) consists of an electronic device contained in a case (“PFS compartment”) that is affixed to a camera or other image-capture device. In its basic form, the PFS consists of two laser projectors. These lasers are parallel, so that they project two spots that are always a known, preset distance apart. In this manner, the size of an object in a photograph taken while using the PFS can be quickly ascertained by scaling the object relative to the distance between the two spots of light. The current method requires a ruler or scale to be placed on or near the object before the photograph is taken to achieve this same goal. Using the PFS is a much faster because the photographer only has to activate the PFS, and then capture images; the scale is automatically captured.

In addition to the spots of light, each projector may display a circle or ring of light. The lenses of the PFS may be configured to project a small focused spot in the center of a diverging ring of light. Thus the projected ring, captured on the surface of an object provides information about the object such as its shape, orientation to the photographer, surface finish, and distance from the photographer. Devices for projecting different patterns of light, including circles and rings, are well known in the art. For example, the Laser Mouse Cat Toy by Doctors Foster and Smith, is light source device capable of projecting complex shapes such as a “mouse-shaped silhouette.” See Laser Mouse Cat Toy at http://www.drsfostersmith.com/product/prod_display.cfm?pcatid=2972&(cmpid=02csegb&ref=3312&(subref=AA&ci_src=14110944&ci_sku=0008829000000 (last visited Dec. 12, 2009). Post-processing software that is also well known in the art could then be used to calculate the original properties (shape, orientation, viewing distance, etc.) of the object from the captured image.

Use of the PFS is very simple. The user only needs to turn the device on, and then capture images as they would ordinarily. The device would require little or no periodic maintenance. In the preferred embodiment, the lens and projector alignment is fixed. In an alternate embodiment, one of the projectors could be fixed within the PFS while the alignment of the other projector could be adjusted by set screws.

The mounting to the imager can take several forms. Most commercially-available imaging devices have a standard threaded hole in their base—designed for mounting the camera on a tripod—which can be used to mount the PFS with a screw. Other mounting alternatives include mounting the device on the outside of the imager lens (such as with a clamp that fits on the outside of a camera lens), or otherwise affixing to the body of the imager (such as with magnets). These alternatives may have advantages including desirable alignment with the lens, but could require camera-specific mounting configurations.

This basic invention can be expanded in a number of areas including separate switches for the dot scale and the projected ring. One method of incorporating this feature is to use separate projectors for the spot scale and the rings. This would be an advantage if it is desired to project the dots and rings eccentrically.

The lasers could also be linked to a camera shutter or flash so that the PFS is only switched on when the picture is taken, thereby increasing the battery life of the device, as well as creating a potentially safer product (if a person looks directly at the beam, shorter-duration laser light is less likely to cause eye damage).

Additionally, the PFS could be configured to produce other shapes or information. In another embodiment, these shapes or information may be created by interchangeable lenses. Other shapes could also be produced by the projector lenses instead of rings. For example, a cross-hairs or square may be preferable by some users. This could even be incorporated in the design through interchangeable lenses.

Another embodiment of the invention would project horizontal and vertical diverging lines (crosshair) through a lens that is not axially symmetric. The rates of divergence for these two lines could be different. In this case, the ratio of the lengths of the two lines could be used to calculate distance from the viewer as well as the size of the object. In this case, the scale measurement that the lines represent would be different for different viewing distances, but would still be constant between targets at the same orientation and distance from the viewer.

At short range, focused LEDs have sufficient brightness to serve as a source for the projected scale, though the precision of the scale may be impacted. In another embodiment of the invention, LEDs could also be used alone or in combination with lasers. For example, lasers could serve to produce the point scale while LEDs could project the ring. In another embodiment of the design, a single light source could also be used to produce multiple beams, through the use of a beam splitter, mirrors, and lenses.

In another embodiment, the PFS can be integrated directly into an image capture device. The PFS's laser used in this device could also be incorporated into a laser rangefinder in a different embodiment. This distance information could then be used directly by the photographer or image capture device (to set flash timings or autofocus, for example) as well as to modulate laser power for eye safety.

1. A projected light scale device, comprising:
a PFS compartment;
one or more light sources contained in said compartment;
one or more lenses attachable to the projecting end of said one or more light sources;
a power source operatively connected to said one or more light sources and contained in said compartment; and
a trigger operatively connected to said power source and said one or more light sources that activates said one or more light sources.

2. The projected light scale device of claim 1, further comprising a mounting feature configured to enable mounting to an image capture device.

3. The projected light scale device of claim 1, wherein said one or more light sources is selected from the group consisting of lasers, LEDs, and incandescent lights.

4. The projected light scale device of claim 1, wherein said one or more light sources project one or more parallel or collimated beams of light.

5. The projected light scale device of claim 1, further comprising an optical beam splitter capable of splitting two beams is attached to the projecting side of said lens, said lens further attached to a single said light source.

6. The projected light scale device of claim 1, wherein said one or more lenses are selected from the group consisting of ground, compound, Fresnel, or masked shaped.

7. The projected light scale device of claim 1, wherein said one or more lenses are configured to create a diverging beam pattern.

8. The projected light scale device of claim 1, further comprising a power switch.

9. The projected light scale device of claim 8, wherein said power switch is activated while an image is captured.

10. The projected light scale device of claim 1, wherein said PFS compartment is directly integrated into an image capture device.

11. The projected light scale device of claim 1, wherein said one or more lenses are configured to create one or more diverging shapes.

12. The device of claim 11, wherein said one or more diverging shapes is selected from the group consisting of a ring, circle, square, and rectangle.

13. The device of claim 11, wherein said one or more diverging shapes consists of two intersecting lines.

14. The device of claim 13, wherein an angle formed by said intersecting lines is 90 degrees.

15. The device of claim 13, wherein said intersecting lines are segmented.

16. A projected light scale device, comprising:
a PFS compartment;
one or more light sources contained in said compartment;
one or more lenses attachable to the projecting end of said one or more light sources;
a power source operatively connected to said one or more light sources and contained in said compartment;
a trigger operatively connected to said power source and said one or more light sources that activates said one or more light sources; and
a power switch operatively connected to said power source and said one or more light sources.

17. A projected light scale device, comprising:
a PFS compartment;
one or more light sources contained in said compartment;
one or more lenses attachable to the projecting end of said one or more light sources;
a power source operatively connected to said one or more light sources and contained in said compartment;
a trigger operatively connected to said power source and said one or more light sources that activates said one or more light sources;
a power switch operatively connected to said power source and said one or more light sources; and
a power indicator operatively connected to said power source.
